(19) United States
(12) Patent Application Publication
(10) Pub. No.: US 2010/0115321 A1
(43) Pub. Date: May 6, 2010

(54) Disk Array Control Apparatus and Information Processing Apparatus

(76) Inventors: Shingo Fujimoto, Tachikawa-shi (JP); Tatsuya Muramatsu, Fuchu-shi (JP); Tsutomu Sonan, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/581,776

(22) Filed: Oct. 19, 2009

(30) Foreign Application Priority Data
Oct. 31, 2008 (JP) 2008-282289

(51) Int. Cl. G06F 1/26

(52) U.S. Cl. 713/340

(57) ABSTRACT

According to one embodiment, a disk array control apparatus includes a volatile memory configured to temporarily store data sent or received by a disk array controller, a first power supply generation circuit configured to generate second power to drive the volatile memory from first power, a second power supply generation circuit configured to generate fourth power to drive the volatile memory from power having a higher voltage selected from the first power and third power supplied from a battery, a first switch configured to interpose in a path flowing the second power, a second switch configured to interpose in a path through which flowing the fourth power, and a power supply switching control unit includes a logic circuit which controls on/off switching of the first switch and the second switch based on a state of a initialization signal.

### CROSS-REFERENCE TO RELATED APPLICATIONS

This application is based upon and claims the benefit of priority from Japanese Patent Application No. 2008-282289, filed Oct. 31, 2008, the entire contents of which are incorporated herein by reference.

### BACKGROUND

1. Field

One embodiment of the invention relates to a disk array control apparatus which has a volatile memory and a battery that protects data stored in the volatile memory, and an information processing apparatus having this disk array control apparatus.

2. Description of the Related Art

In general, a Redundant Arrays of Inexpensive Disks (RAID) card includes a rechargeable battery that protects data stored in a cache memory mounted in the RAID card.

When the voltage of a main body power fed from a main board is reduced, the RAID card switches a drive voltage source of the cache memory to the battery from the main body power supply to protect data stored in the cache memory.

A general architecture that implements the various feature of the invention will now be described with reference to the drawings. The drawings and the associated descriptions are provided to illustrate embodiments of the invention and not to limit the scope of the invention.

Jpn. Pat. Appln. KOKOKU Publication No. 5-9813 (FIG. 1) discloses a configuration in which a main power supply Vcc is led to a load supply terminal through a diode D1, and a diode D2 is interposed in a path through which the load supply terminal receives electric power from a lithium battery.

According to the above-described technology, since the respective power supplies are connected through the diodes, power losses occur in the diodes.

Further, there is a method of detecting a reduction in supply voltage by using, e.g., an operational amplifier or an analog-to-digital converter to switch the voltage in a logic circuit or a microprocessor, but reducing a cost for a monitoring circuit is not easy in a power supply voltage monitoring scheme.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a system configuration of an information processing apparatus according to an embodiment of the present invention;

FIG. 2 is an exemplary perspective view showing a structure of the information processing apparatus according to an embodiment of the present invention;

FIG. 3 is an exemplary view showing a structure of a RAID controller board according to an embodiment of the present invention;

FIG. 4 is an exemplary block diagram showing a structure of a power supply switching circuit according to an embodiment of the present invention;

FIG. 5 is an exemplary circuit diagram showing a structure of a first switch and a second switch according to an embodiment of the present invention;

FIG. 6 is an exemplary block diagram showing a power supply switching control circuit according to an embodiment of the present invention; and

FIG. 7 is an exemplary view showing signals for explaining the operation of the power supply switching control circuit according to an embodiment of the present invention.

### DETAILED DESCRIPTION

Various embodiments according to the invention will be described hereinafter with reference to the accompanying drawings. In general, according to one embodiment of the invention, a disk array control apparatus comprises an expansion board inserted into an expansion slot provided in a main board provided in an information processing apparatus comprising a power supply device and a power supply monitoring circuit outputting an initialization signal when the output voltage of the power supply device becomes lower than a set value, a disk array controller mounted on the expansion board, a volatile memory configured to temporarily store data sent or received by the disk array controller, a first power supply generation circuit configured to generate second power having a voltage required to drive the volatile memory from first power supplied from the main board, a second power supply generation circuit configured to generate fourth power having a voltage required to drive the volatile memory from power having a higher voltage selected from the first power and third power supplied from a battery mounted on the expansion board, a first switch configured to interpose in a path through which the first power supply generation circuit is connected to the volatile memory, a second switch configured to interpose in a path through which the second power supply generation circuit is connected to the volatile memory, and a power supply switching control unit having a logic circuit which controls on/off switching of the first switch and the second switch based on a state of the initialization signal.

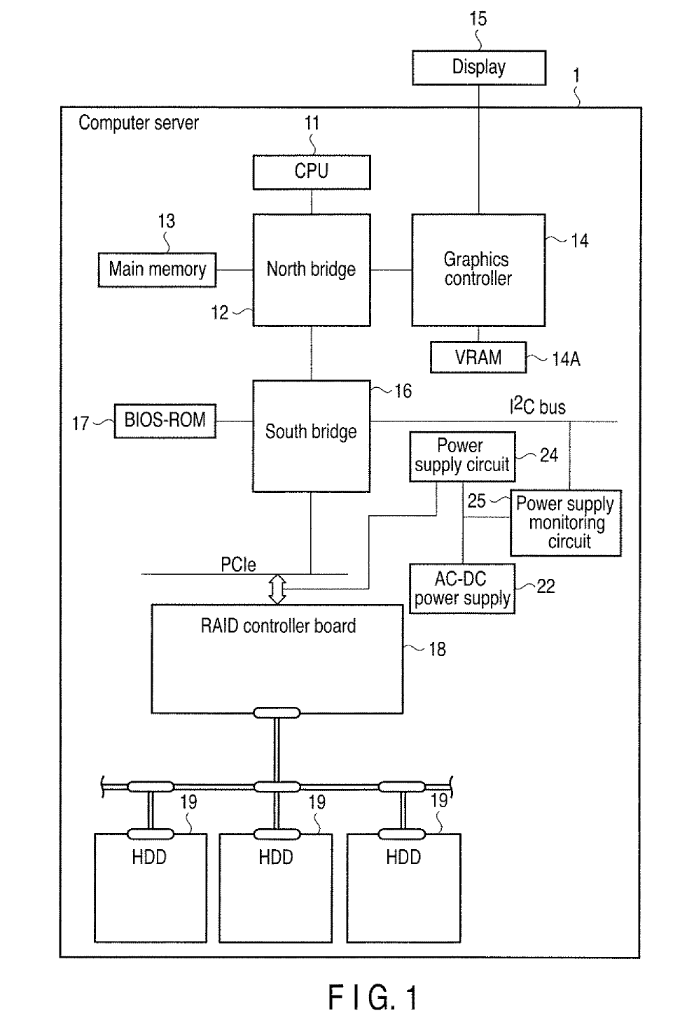

An information processing apparatus according to an embodiment of the present invention will now be described with reference to FIG. 1. The information processing apparatus is realized as a computer server.

FIG. 1 is a block diagram showing a system configuration of this information processing apparatus 1. As shown in FIG. 1, this apparatus 1 includes a CPU 11, a north bridge 12, a main memory 13, a graphics controller 14, a VRAM 14A, a south bridge 16, a BIOS-ROM 17, a RAID controller board 18, hard disk drives (HDDs) 19, an AC-DC power supply 23, a power supply circuit 24, a power supply monitoring circuit 25, and other parts.

The CPU 11 is a processor that controls the operations of the respective units in this information processing apparatus 1. The CPU 11 executes an operating system that is loaded into the main memory 13 from the HDDs 19 or various programs which operates under control of this operating system. Further, the CPU 11 also executes a basic input/output system (BIOS) stored in the BIOS-ROM 17.

The north bridge 12 is a bridge device that connects a local bus of the CPU 11 to the south bridge 16. The north bridge 12 has a function of executing communication with the graphics controller 14 through a bus, and also has a built-in memory controller that performs access control over the main memory 13. The graphics controller 14 is a display controller that controls a display 15 on this apparatus 1 side. The graphics controller 14 generates a picture signal which should be supplied to the display 15 from image data written in the VRAM 14A.

The south bridge 16 is a controller that controls various kinds of devices on a PCI Express (PCIe) bus and an LPC bus. Further, this south bridge 16 is directly connected to the BIOS-ROM 17 and also has a function of controlling it.

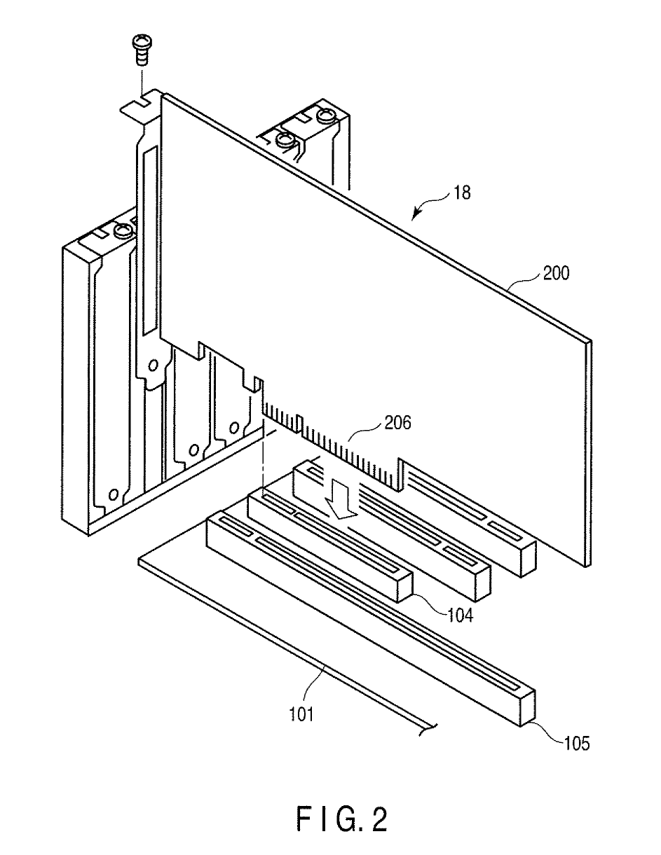

A plurality of expansion slots 104 and 105 provided in a main board 101 are connected to the PCI Express bus, as shown in FIG. 2. It should be noted that a PCI Express expansion board having 8 channels or less can be inserted into the expansion slot 104, and a PCI Express expansion board having 16 channels or less can be inserted into the expansion slot 105. As shown in FIG. 2, a connector unit 206 of an expansion board 200 constituting the RAID controller board 18 is inserted in the expansion slot 104.

The RAID controller board 18 is a controller that controls a disk array formed of the plurality of HDDs 19.

An AC-DC power supply 23 is a converter that generates direct-current power from an alternating-current commercial power supply. The generated power from the AC-DC power supply 23 is supplied to the power supply circuit 24 provided in the main board. The power supply circuit 24 generates power having a voltage that is supplied to each component mounted on the main board and the expansion board inserted in a PCI Express slot.

The power supply monitoring circuit 25 has a function of monitoring the voltage of the power supplied to the power supply circuit 24 from the AC-DC power supply 23 and outputting an initialization signal to the CPU 11 and the expansion board connected to the PCI Express bus when the voltage becomes less than a set value. It should be noted that the voltage used to output the initialization signal is set higher than the voltage that disables each component actually mounted on the main board and the expansion board connected to the PCIe bus.

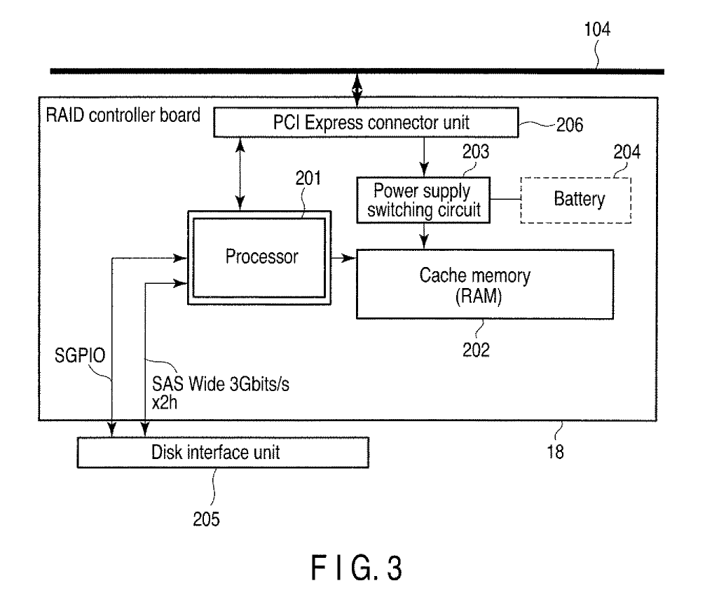

A structure of the RAID controller board 18 will now be described with reference to FIG. 3. The RAID controller board 18 includes a processor (control unit) 201, a cache memory (volatile storage unit, e.g., a RAM) 202, a power supply switching circuit 203, a battery 204, a disk interface unit 205, a PCI Express connector unit 206, and other parts. The processor (control unit) 201, the cache memory 202, the power supply switching circuit 203, the battery 204, and the disk interface unit 205 are mounted on an expansion board 200.

The processor 201 performs, e.g., control over sending/receiving of data with respect to the HDDs 19 connected to the disk interface unit 205. When sending/receiving data between the processor 201 and each HDD 19 connected to the disk interface unit 205, the cache memory 202 temporarily stores data to improve a speed of sending/receiving the data. The battery 204 is a power supply source that is used to back up data stored in the cache memory 202. For example, when supply of main body power from the power supply circuit 24 is stopped, supplying load supply power to the cache memory 202 from the battery 204 enables preventing data stored in the cache memory 202 from being lost.

The power supply switching circuit 203 supplies to the cache memory 202 power generated from the main body power fed from the power supply circuit 24. When the voltage of the power output from the AC-DC power supply 23 is reduced, the power supply switching circuit 203 switches power which is fed to the cache memory 202 to power which is generated from power fed from the battery 204. The power supply switching circuit 203 switches power based on an initialization signal output from the power supply monitoring circuit 25.

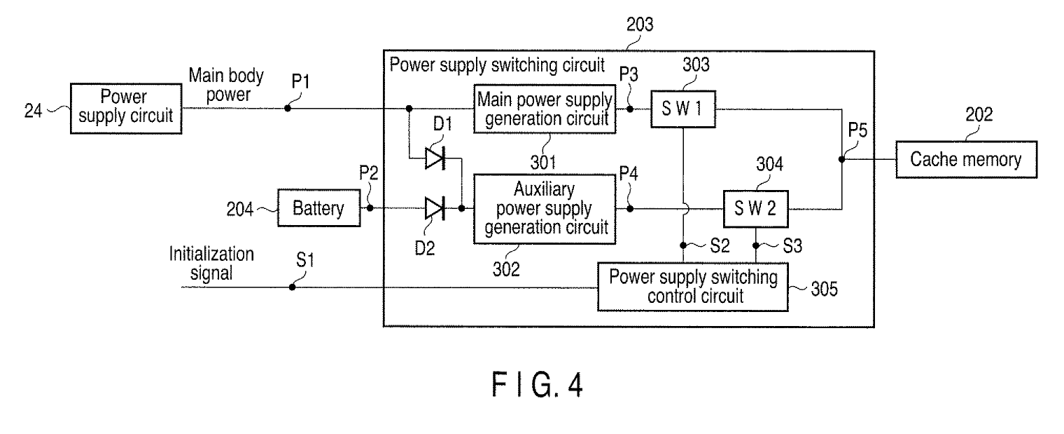

A structure of the power supply switching circuit 203 will now be described with reference to FIG. 4. The power supply switching circuit 203 includes a diode D1, a diode D2, a main power supply generation circuit 301, an auxiliary power supply generation circuit 302, a first switch 303, a second switch 304, a power supply switching control circuit 305, and other parts.

Main body power P1 fed from the power supply circuit 24 mounted on the main board is supplied to the main power supply generation circuit 301. Main body power P4 fed from the power supply circuit 24 is supplied to the auxiliary power supply generation circuit 302 via the first diode D1. Power P2 fed from the battery 204 is supplied to the auxiliary power supply generation circuit 302 through the second diode D2.

The main power supply generation circuit 301 generates main power P3 adapted to a voltage which is utilized to drive the cache memory 202 from input main body power Pl. Main power 23 generated by the power supply generation circuit 301 is supplied to the cache memory 202 through the first switch 303.

The auxiliary power supply generation circuit 302 generates auxiliary power P4 adapted to a voltage which is utilized to drive the cache memory 202 from the input power. Auxiliary power 24 generated by the auxiliary power supply generation circuit 302 is supplied to the cache memory 202 through the second switch 304. Usually, when main body power P1 is normally supplied from the power supply circuit 24, the voltage of main power P1 is higher than the voltage of power P2, and the auxiliary power supply generation circuit 302 generates auxiliary power adapted to a voltage which is utilized to drive the cache memory 202 by using main power P1.

On the other hand, when the voltage of main body power P1 becomes lower than the voltage of power P2, the auxiliary power supply generation circuit 302 uses power P2 fed from the battery 204 to generate auxiliary power P4 adapted to a voltage which is utilized to drive the cache memory 202.

The power supply switching control circuit 305 controls turning on/off of the first switch 303 and the second switch 304. When main body power P1 is supplied to the RAID controller card from the power supply circuit 24, the first switch 303 is turned off, and the second switch 304 is turned on.

When at least one of main body power P1 and power P2 is normally supplied, load supply power P5 supplied to the cache memory 202 becomes at least one of power P3 and power P4 in accordance with control over the first switch 303 and the second switch 304 by the power supply switching control circuit 305.

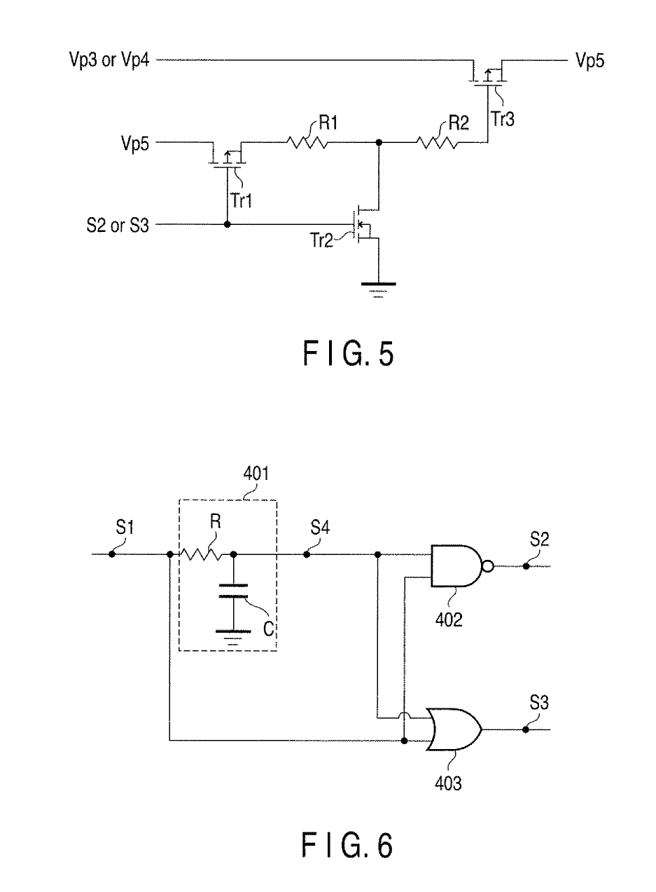

Structures of the first switch 303 and the second switch 304 will now be described with reference to FIG. 5. The structures of the first switch 303 and the second switch 304 are completely the same except for input signals.

As shown in FIG. 5, each of the first switch 303 and the second switch 304 has an NPN transistor Tr1, a PNP transistor Tr2, an NPN transistor Tr3, resistors R1 and R2, and other parts.

A control signal S2 or S3 is input to the base of NPN transistor Tr1 and the base of PNP transistor Tr2. Load supply power P5 is input to the collector of NPN transistor Tr1. The output on the emitter side of NPN transistor Tr1 is input to the base of NPN transistor Tr3 through resistors R1 and R2. The collector of PNP transistor Tr2 is grounded. The output on the collector side of PNP transistor Tr2 is input to a part between resistors R1 and R2. Output power P3 from the main power supply generation circuit 301 or output power P4 from the auxiliary power supply generation circuit 302 is input to the collector side of NPN transistor Tr3. When control signal S2 (S3) goes high, NPN transistor Tr3 is turned on, and load supply power P5 becomes power P3 (P4).

A structure of the power supply switching control circuit 305 will now be described with reference to FIG. 6. The power supply switching control circuit 305 has an RC time constant circuit (delay circuit) 401 formed of a resistor R and a capacitor C, a NAND gate 402, an OR gate 403, and other parts. An initialization signal and another initialization signal which is sent through the RC time constant circuit 401 are input to the NAND gate 402. An initialization signal and another initialization signal which is sent through the RC time constant circuit 401 are input to the OR gate 403.

When main body power P1 is supplied from the power supply circuit 24 on the main board but an initialization signal S1 is not sent, the output from the NAND gate 402 is high, and the output from the OR gate 403 is low. Therefore, since a signal S2 fed to the first switch 303 is high, the first switch 303 is turned on. Furthermore, since a signal S3 fed to the second switch 304 is low, the second switch 304 is turned off.

When the initialization signal S1 is sent in this state, the output from the OR gate 403 goes high, and the output from the NAND gate 402 goes low after elapse of a delay time. The delay time is determined based on the resistance R and capacitance C of the RC time constant circuit 401.

The power supply monitoring circuit 25 outputs the initialization signal before the RAID controller board 18 becomes inoperative, and hence switching processing can be executed before the drive voltage is reduced.

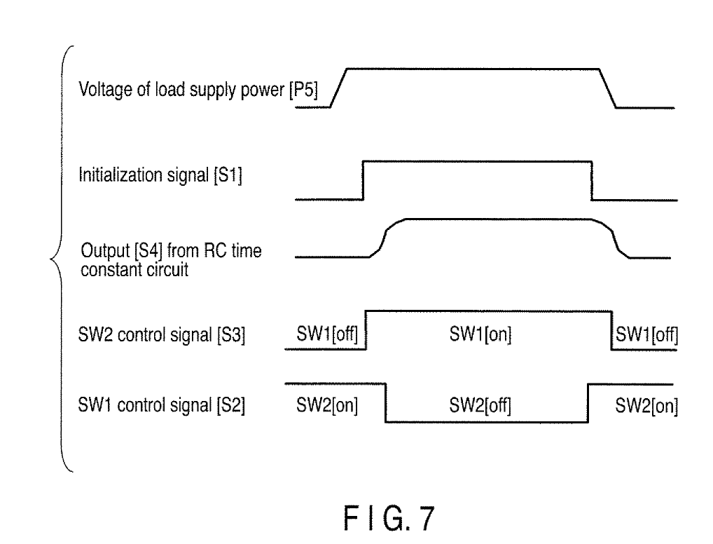

The operation of this power supply switching control circuit 305 will now be described in detail with reference to FIG. 7.

State 1

When the initialization signal S1 is low, the first switch control signal 52 is low and the second switch control signal S3 is high, as shown in FIG. 6. Therefore, since the first switch 303 is off and the second switch is on, load supply power P5 is power P4 generated by the auxiliary power supply generation circuit 302.

State 2

When the initialization signal goes high, the first switch control signal S2 and the second switch control signal S3 are changed to high, as shown in FIG. 6. Therefore, both the first switch 303 and the second switch 304 are turned on, load supply power P5 is power P3 generated by the main power supply generation circuit 301 and power P4 generated by the auxiliary power supply generation circuit 302.

This state is maintained until a delay signal S4 generated from the initialization signal S1 through the RC time constant circuit 401 exceeds the input high-voltage threshold of the NAND gate 402 and the OR gate 403. When load supply power P5 supplied to the cache memory 202 becomes power P3 generated by the main power supply generation circuit 301 and power P4 generated by the auxiliary power supply generation circuit 302, rising state of the voltage of power P3 generated by the main power supply generation circuit 301 and a falling state of the voltage of power P4 generated by the auxiliary power supply generation circuit 302 are avoided, and a fluctuation in voltage of load supply power P5 fed to the cache memory 202 is reduced.

State 3

When the delay signal S4 of the initialization signal S1 exceeds the threshold voltage of the NAND gate 402 and the OR gate 403, the first switch control signal S2 goes high, and the second switch control signal S3 goes low. Therefore, since the first switch 303 is on and the second switch is off, load supply power P5 becomes power P3 generated by the main power supply generation circuit 301.

State 4

When the information processing apparatus main body is initialized or enters a power-supply-off mode, the initialization signal S1 goes low, the first switch control signal S2 goes low, and the second switch control signal S3 goes high. Therefore, since the first switch 303 turns off and the second switch 304 turns on, load supply power P5 becomes power P3 generated by the main power supply generation circuit 301 and power P4 generated by the auxiliary power generation circuit 302. This state is maintained until the delay signal S4 of the initialization signal S1 exceeds the input low-voltage threshold of the NAND gate 402 and the OR gate 403. In this state 4, a fluctuation in voltage when shifting to state 1 is reduced like state 2.

The power supplies from both the main body power supply and the battery 204 are continuously supplied to a point P5 until feeding of these power supplies is stopped at the same time, and data stored in the cache memory 202 can be continuously held without being volatilized.

In the RAID controller board 18 in this embodiment, the control for switching the drive power generation sources for the cache memory 202 can be constituted of a general logic component main body, the circuits can be configured at a low cost, and retentiveness of stored contents in the cache memory 202 can be improved.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk array control apparatus comprising:
an expansion board inserted into an expansion slot provided in a main board provided in an information processing apparatus comprising a power supply device and a power supply monitoring circuit outputting an initialization signal when the output voltage of the power supply device becomes lower than a set value;
a disk array controller mounted on the expansion board;
a volatile memory configured to temporarily store data sent or received by the disk array controller;
a first power supply generation circuit configured to generate second power having a voltage required to drive the volatile memory from first power supplied from the main board;
a second power supply generation circuit configured to generate fourth power having a voltage required to drive the volatile memory from power having a higher voltage selected from the first power and third power supplied from a battery mounted on the expansion board;
a first switch configured to interpose in a path through which the first power supply generation circuit is connected to the volatile memory;
a second switch configured to interpose in a path through which the second power supply generation circuit is connected to the volatile memory; and
a power supply switching control unit having a logic circuit which controls on/off switching of the first switch and the second switch based on a state of the initialization signal.

2. The apparatus of claim 1, wherein the power supply switching control unit comprises a power supply switching control module configured to turn off the first switch and to turn on the second switch when the initialization signal is low, to turn on the first switch and to turn off the second switch when the initialization signal changes from low to high, and to turn off the first switch and to turn on the second switch when the initialization signal changes from high to low.

3. The apparatus of claim 2, wherein the power supply switching control module is configured to turn on the first switch after turning off the second switch when the initialization signal is changed from high to low.

4. The apparatus of claim 3, wherein the power supply switching control module comprising:
a delay circuit configured to be input the initialization signal and to output a delayed initialization signal obtained by delaying the input initialization signal;
a NAND gate configured to receive the initialization signal and the delayed initialization signal, the output signal thereof becoming a control signal for the first switch; and
an OR gate configured to receive the initialization signal and the delayed initialization signal, the output signal thereof becoming a control signal for the second switch.

5. An information processing apparatus comprising:
a power supply device configured to output first power;
a main board;
a first power supply circuit provided on the main board and configured to generate second power from first power supplied from the power supply device;
a power supply monitoring circuit configured to output an initialization signal when the voltage of the first power is less than a set value;
an expansion slot provided in the main board; and
a power supply switching control unit comprising an expansion board inserted into the expansion slot, a disk array controller mounted on the expansion board, a volatile memory configured to temporarily stores data sent or received by the disk array controller, a first power supply generation circuit configured to generate second power having a voltage required to drive the volatile memory from the first power supplied from the main board, a second power supply generation circuit configured to generate fourth power having a voltage required to drive the volatile memory from power having a higher voltage selected from the first power and third power supplied from a battery mounted on the expansion board, a first switch configured to interpose in a path through which the first power supply generation circuit is connected to the volatile memory, a second switch configured to interposed in a path through which the second power supply generation circuit is connected to the volatile memory, and a logic circuit configured to receive the initialization signal and controls on/off switching of the first switch and the second switch in accordance with the initialization signal.

6. The apparatus of claim 5, wherein the power supply switching control unit comprises a power supply switching control module configured to turn off the first switch and to turn on the second switch when the initialization signal is low, to turn on the first switch and turns off the second switch when the initialization signal is changed from low to high, and to turn off the first switch and to turn on the second switch when the initialization signal is changed from high to low.

7. The apparatus of claim 6, wherein the power supply switching control module is configured to turn on the first switch after turning off the second switch when the initialization signal is changed from high to low.

8. The apparatus of claim 7, wherein the power supply switching control module comprising:
a delay circuit configured to be input the initialization signal and to output a delayed initialization signal obtained by delaying the input initialization signal;
a NAND gate configured to receive the initialization signal and the delayed initialization signal, the output signal thereof becoming a control signal for the first switch; and
an OR gate configured to receive the initialization signal and the delayed initialization signal, the output signal thereof becoming a control signal for the second switch.
